(19) United States
(12) Patent Application Publication
(10) Pub. No.: US 2026/0104073 A1
(43) Pub. Date: Apr. 16, 2026

(54) BEARING SYSTEM

(71) Applicant: Mazda Motor Corporation, Aki-gun (JP)

(72) Inventors: Yusuke Nakao, Aki-gun (JP); Yoshitomo Takahashi, Aki-gun (JP); Yuma Miyauchi, Aki-gun (JP)

(21) Appl. No.: 19/351,564

(22) Filed: Oct. 7, 2025

(30) Foreign Application Priority Data
Oct. 15, 2024 (JP) 2024-179812

(51) Int. Cl. F16C 33/10; F16C 17/02

(52) U.S. Cl. CPC F16C 33/1045; F16C 17/02; F16C 2380/26

(57) ABSTRACT

A bearing system is capable of securing load capacity without increasing resistance for a slide bearing using a fluid having a high viscosity and a fluid having a low viscosity. The bearing system includes a slide bearing lubricated by oil and a refrigerant (a CO₂ refrigerant) and supporting a rotation shaft; oil passages for supplying the oil to a first region of a sliding surface of the slide bearing; and a refrigerant passage provided away from the oil passages in an axial direction and supplying a refrigerant to a second region different from the first region in the sliding surface, and the slide bearing is formed such that an inner diameter of the second region is smaller than an inner diameter of the first region.

### TECHNICAL FIELD

The present disclosure relates to a bearing system that supports a rotation shaft by a slide bearing lubricated by a fluid.

### BACKGROUND ART

Conventionally, a slide bearing configured to be lubricated by a fluid (a working fluid) such as oil to support a rotation shaft has been known. This type of a technique is described in JP2022-155811A, for example. This JP2022-155811A discloses a technique of making an auxiliary bearing as a rolling bearing function as a slide bearing (a fluid bearing) by supplying a refrigerant (example of the fluid) to a gap between an inner wheel thereof and the rotation shaft and thereby alleviating an effect of frictional heat that is generated in the auxiliary bearing and the rotation shaft.

In addition, a technique related to the present disclosure is described in WO2010/038588A1, for example. In WO2010/038588A1, it is described that a sliding surface of a slide bearing is formed as a crowning type that includes a tilted surface in order to suppress edge loading of the slide bearing and a rotation shaft.

### SUMMARY

### TECHNICAL PROBLEM

Here, the present inventors have studied an application of a slide bearing to a rotation shaft such as that of a motor that can rotate at a high rotational frequency (for example, a motor of an electric vehicle), and have obtained the following knowledge in a process of developing this slide bearing.

First, when the rotational frequency of the rotation shaft is relatively low, a load capacity of the slide bearing tends to be low. Meanwhile, when the rotational frequency of the rotation shaft is relatively high, the load capacity of the slide bearing tends to be increased due to a wedge effect and a throttle effect, but loss (friction loss) due to resistance of a fluid tends to also be increased. Accordingly, it can be said that it is desirable to secure the load capacity of the slide bearing in a low rotation range of the rotation shaft and that it is desirable to suppress the load capacity of the slide bearing to reduce the friction loss in a high rotation range of the rotation shaft. Therefore, the present inventors have considered using the fluid having a high viscosity and the fluid having a low viscosity, and the fluid having a high viscosity is mainly applied to the slide bearing in the low rotation range of the rotation shaft, while the fluid having a low viscosity is mainly applied to the slide bearing in the high rotation range of the rotation shaft.

However, when the use of the fluid having the high viscosity in the slide bearing is considered, a large resistance is generated by the excessively small gap between the sliding surface of the slide bearing and the rotation shaft. Thus, it can be said that it is desirable to increase the gap to some extent. Meanwhile, when the use of the fluid having the low viscosity in the slide bearing is considered, the load capacity of the slide bearing cannot be secured by an increase in the gap between the sliding surface and the rotation shaft as described above. Thus, it is desirable to reduce the gap. If the load capacity is not secured, new resistance may be generated due to radial displacement of the rotation shaft.

The present disclosure has been made to solve the above-described problems of the related art, and an object of the present disclosure is to provide a bearing system capable of securing the load capacity of the slide bearing, which uses a fluid having a high viscosity and a fluid having a low viscosity, without increasing resistance.

### SOLUTION TO PROBLEM

In order to achieve the above object, the present disclosure provides a bearing system, which includes: a slide bearing that is lubricated by a first fluid and a second fluid having a lower viscosity than the first fluid and supports a rotation shaft; a first passage for supplying the first fluid to a first region of a sliding surface of the slide bearing; and a second passage that is provided away from the first passage in an axial direction and supplies the second fluid to a second region that differs from the first region in the sliding surface, in which the slide bearing is formed such that an inner diameter of the second region is smaller than an inner diameter of the first region.

According to this configuration, since the inner diameter of the second region, to which the second fluid having a relatively low viscosity is supplied, is smaller than the inner diameter of the first region, to which the first fluid having a relatively high viscosity is supplied, in the slide bearing, a gap between the sliding surface of the slide bearing and an outer circumferential surface of the rotation shaft is smaller in the second region than in the first region. As a result, since the gap in the second region, to which the second fluid is supplied, is relatively small, the load capacity by the second fluid in this second region can be secured. Meanwhile, since the gap in the first region, to which the first fluid is supplied, is relatively large, it is possible to suppress an increase in resistance by the first fluid in this first region. Thus, according to the present disclosure, in the slide bearing that uses the first and second fluids having the different viscosities, it is possible to secure the load capacity without increasing the resistance. Therefore, when the second fluid having the relatively low viscosity is applied, it is possible to prevent a wasteful increase in the resistance caused by displacement of the rotation shaft in the radial direction.

In the present disclosure, preferably, the slide bearing is formed such that an inner diameter of the sliding surface is continuously changed along the axial direction in a manner which makes the inner diameter of the second region smaller than the inner diameter of the first region.

According to this configuration, since the gap between the sliding surface of the slide bearing and an outer circumferential surface of the rotation shaft is continuously changed along the axial direction, it is possible to make a surface pressure applied to the sliding surface uniform.

In the present disclosure, preferably, the slide bearing is formed such that a cross section of the sliding surface viewed along the axial direction has an arc shape.

According to this configuration, it is possible to effectively make the surface pressure applied to the sliding surface uniform.

In the present disclosure, preferably, the slide bearing is one of a pair of slide bearings provided to support the rotation shaft, and each of the paired slide bearings has the respective first region in one or both of the end portions in the axial direction, and has the respective second region in an intermediate portion between both of the end portions in the axial direction.

According to this configuration, the first fluid having the relatively high viscosity is supplied to one or both of the end portions in the axial direction, while the second fluid having the relatively low viscosity is supplied to the intermediate portion (typically a central portion) in the axial direction. In this way, it is possible to effectively secure the load capacity of the slide bearing, in particular, the load capacity by the second fluid.

In the present disclosure, preferably, the bearing system further includes: a third passage for supplying the second fluid to the first region; a first valve and a second valve provided in the first passage and the third passage, respectively; and a controller that controls opening/closing of each of the first valve and the second valve to switch a fluid to be supplied to the first region between the first fluid and the second fluid.

According to this configuration, the bearing system can selectively supply the second fluid instead of the first fluid to the first region. In this way, it is possible to effectively suppress the increase in the resistance caused by application of the first fluid in the slide bearing.

In the present disclosure, preferably, based on a rotational frequency of the rotation shaft, the controller selectively executes a control for opening the first valve and closing the second valve to supply the first fluid to the first region and a control for closing the first valve and opening the second valve to supply the second fluid to the first region.

According to this configuration, since the fluid supplied to the first region is switched between the first fluid and the second fluid on the basis of the rotational frequency of the rotation shaft, it is possible to accurately secure the load capacity in a low rotation range and reduce the resistance in a high rotation range.

In the present disclosure, preferably, the slide bearing further includes: a groove portion that is formed in the sliding surface and extends in a radial direction and a circumferential direction, the groove portion dividing the sliding surface into a plurality of divided sections (example of the plurality of sections) in the axial direction; and a discharge hole that is formed in the groove portion to discharge the first and second fluids from the slide bearing, and each of the first region and the second region is defined by a respective one of the plurality of sections divided by the groove portion.

According to this configuration, since each of the fluids (the first fluid or the second fluid) in each of the divided sections flows out from the discharge hole through the groove portion that defines each of the divided sections, it is possible to prevent the fluid from being mixed in adjacent divided sections. Thus, it is possible to prevent the fluid from being mixed in a portion between the first region and the second region that are defined by the divided sections. Therefore, according to the present disclosure, it is possible to effectively secure the load capacity by the slide bearing and reduce the resistance.

In a preferred example in the present disclosure, the first fluid is oil, and the second fluid is CO₂.

In this case, in a further preferred example, the bearing system supports the rotation shaft of a motor by the slide bearing.

### ADVANTAGEOUS EFFECTS

According to the bearing system of the present disclosure, it is possible to secure the load capacity without increasing the resistance for the slide bearing that uses the fluid having the high viscosity and the fluid having the low viscosity.

### BRIEF DESCRIPTION OF DRAWINGS

FIG. 1 is a schematic configuration view of a vehicle to which a bearing system according to an embodiment of the present disclosure is applied.

FIG. 2 is a schematic configuration view of a refrigerant circulation system according to the embodiment of the present disclosure.

FIG. 3 is a schematic configuration view of a motor and the like according to the embodiment of the present disclosure.

FIGS. 4A and 4B are schematic configuration views of the bearing system according to the embodiment of the present disclosure.

FIGS. 5A, 5B, and 5C are views illustrating switching between oil and a refrigerant in a low rotation range, a medium rotation range, and a high rotation range in the bearing system according to the embodiment of the present disclosure.

FIG. 6 is a block diagram illustrating an electrical configuration of the bearing system according to the embodiment of the present disclosure.

FIG. 7 is a time chart illustrating control according to the embodiment of the present disclosure.

FIG. 8 is a flowchart illustrating the control according to the embodiment of the present disclosure.

### DETAILED DESCRIPTION

Hereinafter, a bearing system according to an embodiment of the present disclosure will be described with reference to the accompanying drawings.

### Overall Configuration

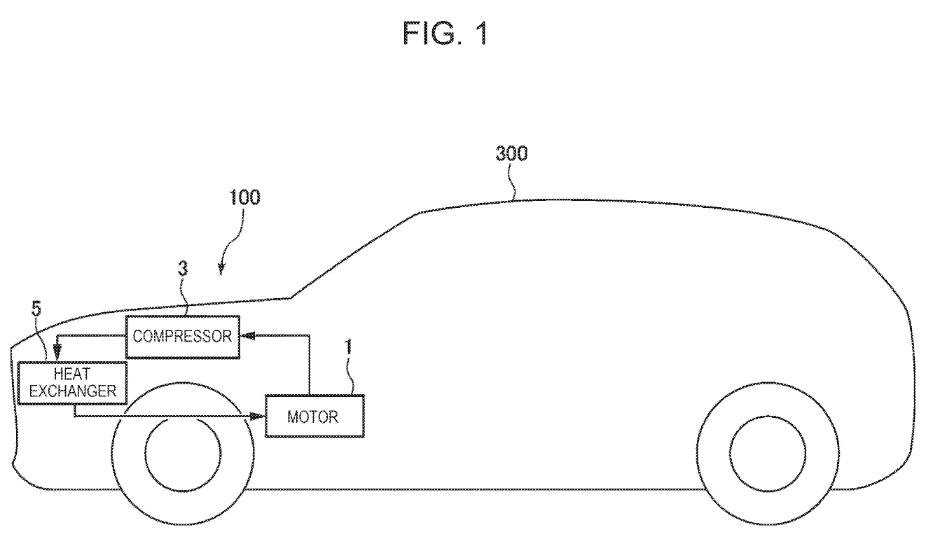

First, FIG. 1 is a schematic configuration view of a vehicle to which the bearing system according to the present embodiment is applied.

As illustrated in FIG. 1, a vehicle 300 is an electric vehicle, for example, and includes a refrigerant circulation system 100 that circulates a refrigerant in a refrigeration cycle. This refrigerant circulation system 100 mainly includes: a motor 1 (an electric motor) that generates power for driving the vehicle 300; a compressor 3 that compresses the refrigerant to be supplied to the motor 1; and a heat exchanger 5 that includes a condenser, a fan, and the like and cools the refrigerant compressed by the compressor 3.

The refrigerant circulation system 100 circulates a CO₂ refrigerant (hereinafter, also simply referred to as the "refrigerant") as a natural refrigerant. This CO₂ refrigerant contains not only CO₂ but also oil (refrigerant oil) such as polyalkylene glycol (PAG), an additive, and the like. Due to use of such a CO₂ refrigerant, the compressor 3 is configured to compress the refrigerant at an extremely high pressure. The motor 1 uses the refrigerant (typically a refrigerant in a supercritical state), which is thus-compressed by the compressor 3, to lubricate a slide bearing supporting a rotation shaft and to cool a rotor and a stator. In this case, the motor 1 is configured to function as an evaporator in the refrigeration cycle. For example, in the refrigerant circulation system 100, a high-temperature liquid refrigerant is supplied from the compressor 3 to the heat exchanger 5, a low-temperature liquid refrigerant is supplied from the heat exchanger 5 to the motor 1, and a high-temperature gas refrigerant is supplied from the motor 1 to the compressor 3. The refrigerant that is compressed by the compressor 3 may be used for air conditioning by an air conditioner, cooling of a battery, or the like.

### Configuration of Refrigerant Circulation System

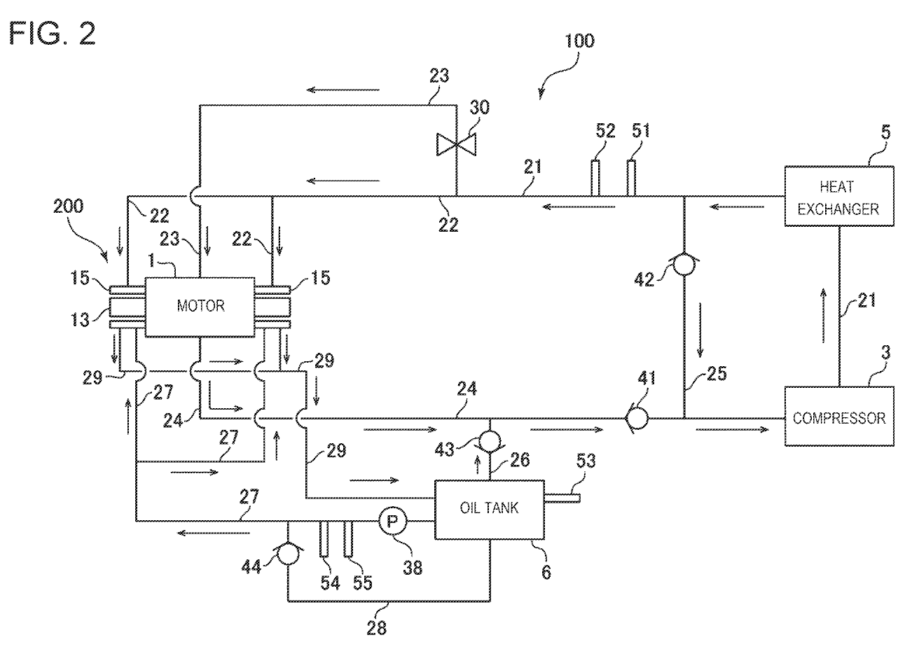

Next, a specific description will be made on the refrigerant circulation system 100 according to the present embodiment with reference to FIG. 2. FIG. 2 is a schematic configuration view of the refrigerant circulation system 100 according to the present embodiment.

As illustrated in FIG. 2, the refrigerant circulation system 100 mainly includes, in addition to the motor 1, the compressor 3, and the heat exchanger 5 described above: a bearing system 200 that includes a pair of slide bearings 15 supporting a rotation shaft 13 of the motor 1; an oil tank 6 that stores the oil used for lubrication of the slide bearings 15 and the like; refrigerant passages 21 to 26 through each of which the refrigerant (e.g. the CO₂ refrigerant) flows; oil passages 27, 28 through which the oil flows; and at least one mixed fluid passage 29 through which a mixed fluid of the refrigerant and the oil flows. For example, the oil is the refrigerant oil such as PAG.

The refrigerant passage 21 is a passage for supplying the refrigerant from the compressor 3 to the motor 1 and the like via the heat exchanger 5, and is branched into the at least one refrigerant passage 22 and the refrigerant passage 23 downstream of the heat exchanger 5. The refrigerant passage 21 is provided with a refrigerant temperature sensor 51 that detects the temperature of the refrigerant and a refrigerant pressure sensor 52 that detects a pressure of the refrigerant.

Hereinafter, description with respect to FIG. 2 will be made to mainly one of the slide bearings 15 as a representative example of the pair. The at least one refrigerant passage 22 is a passage for supplying the refrigerant into the slide bearing 15, and the refrigerant passage 23 is a passage for supplying the refrigerant into the motor 1. These refrigerant passages 22, 23 supply the liquid refrigerant (typically in the supercritical state) to the slide bearing 15 and the motor 1, respectively. The refrigerant supplied to the slide bearing 15 is used to lubricate the slide bearing 15, and the refrigerant supplied to the motor 1 is used to cool the inside of the motor 1. The refrigerant passage 23 is provided with the flow rate adjustment valve 30 that adjusts the flow rate of the refrigerant.

The refrigerant passage 24 is a passage for supplying the refrigerant discharged from the motor 1 to the compressor 3. A refrigerant passage 25 is connected to the refrigerant passage 24. This refrigerant passage 25 has one end that is connected to the refrigerant passage 21 downstream of the heat exchanger 5 and the other end that is connected to the refrigerant passage 24, and functions to return the refrigerant from the heat exchanger 5 to the compressor 3 without interposing the motor 1, the slide bearing 15, and the like. The refrigerant passages 24, 25 are provided with check valves 41, 42, respectively.

The at least one oil passage 27 is a passage for supplying the oil stored in the oil tank 6 to the slide bearing 15. The oil supplied to the slide bearing 15 is used to lubricate the slide bearing 15 together with the refrigerant described above. The at least one oil passage 27 is provided with: an oil pump 38 for pressure-feeding the oil; an oil temperature sensor 54 that detects a temperature of the oil; and a hydraulic pressure sensor 55 that detects a pressure of the oil. The oil passage 28 for returning the oil in the at least one oil passage 27 to the oil tank 6 is connected to the at least one oil passage 27. This oil passage 28 is provided with a check valve 44.

The at least one mixed fluid passage 29 is a passage for supplying the mixed fluid of the refrigerant and the oil discharged from the slide bearing 15 to the oil tank 6. The oil tank 6 is configured to separate the oil in the mixed fluid supplied from this at least one mixed fluid passage 29 (gas-liquid separation) and store the separated oil while supplying the rest of the refrigerant (containing a slight amount of the oil) from the refrigerant passage 26 to the refrigerant passage 24 described above. This refrigerant passage 26 is provided with a check valve 43. The oil tank 6 is provided with an oil level sensor 53 that detects a level of the stored oil.

### Configuration of Bearing System

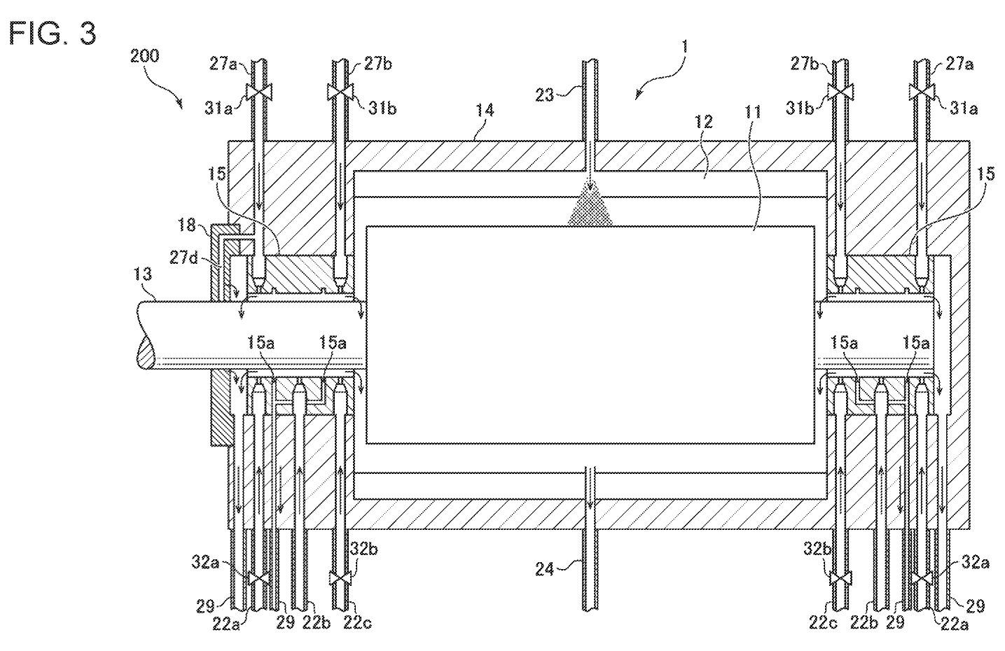

Next, a specific description will be made on a configuration of the bearing system 200 according to the present embodiment with reference to FIGS. 3 to 5.

First, FIG. 3 is a schematic configuration view of the motor 1 and the bearing system 200 according to the present embodiment. More specifically, FIG. 3 is a cross-sectional view in which the motor 1 and the bearing system 200 are viewed along an axial direction. Here, FIG. 3 illustrates vertical positions of the at least one refrigerant passage 22 and the at least one oil passage 27 in reverse of the positions in in FIG. 2 (the same applies to the drawings described below).

As illustrated in FIG. 3, the motor 1 mainly includes a rotor 11, a stator 12, the rotation shaft 13 coupled to this rotor 11 and having one end connected to a transaxle (not illustrated) of the vehicle 300 or the like, and a housing 14 that accommodates the rotor 11, stator 12, and rotation shaft 13, and the bearing system 200 mainly includes the pair of the slide bearings 15 that supports the rotation shaft 13 of the motor 1. The pair of the slide bearings 15 is also accommodated in the housing 14 of the motor 1.

As described above, in the motor 1, the refrigerant (the liquid refrigerant) is supplied from the refrigerant passage 23 to the rotor 11 and the stator 12. The refrigerant that is supplied to the motor 1, just as described, is used to cool the rotor 11 and the stator 12, in particular, to cool a coil (not illustrated) in the stator 12. In this case, since the refrigerant exchanges heat with the stator 12 and the like at a relatively high temperature (at this time, the refrigerant is evaporated in the coil of the stator 12), the function of the evaporator in the refrigeration cycle is realized. Then, the refrigerant used for cooling in the motor 1 is discharged from the refrigerant passage 24.

Subsequently, the pair of the slide bearings 15 are arranged to oppose each other symmetrically (bilaterally symmetrically) across the rotor 11 in the axial direction. Each of the paired slide bearings 15 is supplied with the oil from two of the oil passages 27 (27a, 27b) and supplied with the refrigerant from three of the refrigerant passages 22 (22a, 22b, 22c). The refrigerant and oil are supplied to a gap between an inner peripheral surface of each of the slide bearings 15 and an outer peripheral surface of the rotation shaft 13 of the motor 1, and are thereby used for lubrication when the slide bearings 15 support the rotation shaft 13. The refrigerant and the oil used to lubricate the slide bearings 15 are discharged together as the mixed fluid from the at least one mixed fluid passage 29.

More specifically, the oil passages 27a, 27b supply the oil to different portions (e.g. two portions) of each of the slide bearings 15 along the axial direction, and the refrigerant passages 22a, 22b, 22c supply the refrigerant to different portions (e.g. three portions) of each of the slide bearings 15 along the axial direction. In detail, the oil passage 27a is configured to supply the oil to a first side end portion (a side opposite to the rotor 11) of the slide bearing 15 in the axial direction, and the oil passage 27b is configured to supply the oil to a second side end portion (the rotor 11 side) of the slide bearing 15 in the axial direction. The refrigerant passage 22a is configured to supply the refrigerant to the first side end portion of the slide bearing 15 in the axial direction, the refrigerant passage 22b is configured to supply the refrigerant to a central portion of the slide bearing 15 in the axial direction, and the refrigerant passage 22c is configured to supply the refrigerant to the second side end portion of the slide bearing 15 in the axial direction. In this case, a pair of the oil passage 27a and the refrigerant passage 22a and a pair of the oil passage 27b and the refrigerant passage 22c each supply the oil and the refrigerant to substantially the same portions in the axial direction. That is, the portion where the oil passage 27a supplies the oil and the portion where the refrigerant passage 22a supplies the refrigerant are substantially the same in the axial direction, and the portion where the oil passage 27b supplies the oil and the portion where the refrigerant passage 22c supplies the refrigerant are substantially the same in the axial direction. Meanwhile, the oil is not supplied to the portion where the refrigerant passage 22b supplies the refrigerant in the axial direction.

In addition, the bearing system 200 includes: oil bearing valves 31a, 31b that are provided in the oil passages 27a, 27b, respectively, and can switch supply/blockage of the oil by opening/closing; and refrigerant bearing valves 32a, 32b that are provided in the refrigerant passages 22a, 22c and can switch supply/blockage of the refrigerant by opening/closing.

Meanwhile, the housing 14 of the motor 1 is provided with a seal member 18 for sealing a side of the rotation shaft 13 connected to the transaxle or the like (a side provided with the slide bearing 15 and illustrated on the left in FIG. 3). This seal member 18 is provided to prevent leakage of the fluid from a gap between the housing 14 and a portion of the rotation shaft 13 extending outward from the housing 14. The seal member 18 is configured as a mechanical seal that is supplied with the oil from the oil passage 27d connected to the oil passage 27a described above and uses this oil to prevent the leakage of the fluid.

Here, the oil is an example of a "first fluid" in the present disclosure, and the refrigerant is an example of a "second fluid" in the present disclosure. The oil passages 27a, 27b are examples of the "first passage" in the present disclosure, the refrigerant passage 22b is an example of the "second passage" in the present disclosure, and the refrigerant passages 22a, 22c are examples of the "third passage" in the present disclosure. In addition, each of the oil bearing valves 31a, 31b and each of the refrigerant bearing valves 32a, 32b are examples of the "first valve" and the "second valve" in the present disclosure, respectively.

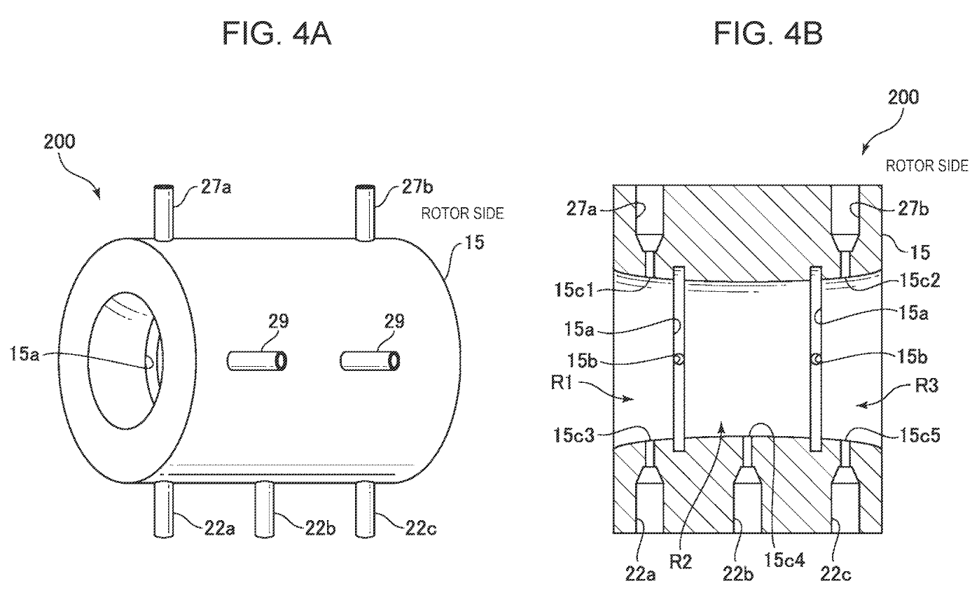

Next, FIG. 4 includes schematic configuration views for more specifically illustrating the bearing system 200 according to the present embodiment. More specifically, FIG. 4A is a perspective view of one of the paired slide bearings 15 in the bearing system 200 (the slide bearing 15 illustrated on the left in FIG. 3, that is, the slide bearing 15 on the side where the seal member 18 is provided), and FIG. 4B is a cross-sectional view in which this one slide bearing 15 is viewed along the axial direction.

As illustrated in FIGS. 4A and 4B, in particular FIG. 4B, the slide bearing 15 has two annular groove portions 15a that are formed on a sliding surface (the inner peripheral surface) thereof, extend in a radial direction, and extend over an entire circumference in a circumferential direction. These two groove portions 15a of the slide bearing 15 divide the sliding surface of the slide bearing 15 into three divided sections R1 to R3 in the axial direction. The divided sections R1, R3 in both end portions have substantially the same length along the axial direction. However, the divided section R2 in an intermediate portion sandwiched between these divided sections R1, R3 is longer along the axial direction than the divided sections R1, R3.

The slide bearing 15 further includes: a discharge hole 15b that is formed in each of the two groove portions 15a to discharge the refrigerant and the oil from the slide bearing 15; supply holes 15c1, 15c2 for respectively supplying the oil to the divided sections R1, R3; and supply holes 15c3, 15c4, 15c5 for respectively supplying the refrigerant to the divided sections R1, R2, R3. The discharge hole 15b communicates with the at least one mixed fluid passage 29, the supply holes 15c1, 15c2 communicate with the oil passages 27a, 27b, respectively, and the supply holes 15c3, 15c4, 15c5 communicate with the refrigerant passages 22a, 22b, 22c, respectively. In this case, the oil passage 27a is configured to supply the oil to the divided section R1 in an end portion on an opposite side from the rotor 11 in the axial direction among the divided sections R1 to R3, and the oil passage 27b is configured to supply the oil to the divided section R3 in an end portion on the rotor 11 side in the axial direction among the divided sections R1 to R3. In addition, the refrigerant passage 22a is configured to supply the refrigerant to the divided section R1 in the end portion on the opposite side from the rotor 11 in the axial direction among the divided sections R1 to R3, the refrigerant passage 22b is configured to supply the refrigerant to the divided section R2 in the central portion in the axial direction among the divided sections R1 to R3, and the refrigerant passage 22c is configured to supply the refrigerant to the divided section R3 in the end portion on the rotor 11 side in the axial direction among the divided sections R1 to R3. The two or more discharge holes 15b may be provided on the same groove portion 15a.

According to such a slide bearing 15, the three divided sections R1 to R3 are formed in the axial direction by the two groove portions 15a, and these groove portions 15a are provided with the discharge holes 15b. Thus, the fluid (the oil or the refrigerant) in each of the divided sections R1 to R3 flows out from the respective discharge hole 15b through respective one of the groove portions 15a that define the divided sections R1 to R3. In this way, it is possible to prevent the fluid from moving back and forth between the adjacent two of the divided sections R1 to R3 and thereby prevent the fluid from being mixed in the divided sections R1 to R3. This is because, since a size (for example, in an order of mm) of the groove portion 15a is significantly larger than a gap (for example, in an order of μm) between the rotation shaft 13 of the motor 1 and the slide bearing 15, the fluid in each of the divided sections R1 to R3 flows into the respective groove portion 15a without flowing to the adjacent divided section by passing the groove portion 15a.

Here, only the refrigerant is supplied to the divided section R2 through the refrigerant passage 22b and the supply hole 15c4. Meanwhile, the oil is supplied to the divided section R1 through the oil passage 27a and the supply hole 15c1, and the refrigerant is supplied through the refrigerant passage 22a and the supply hole 15c3. Meanwhile, the oil is supplied to the divided section R3 through the oil passage 27b and the supply hole 15c2, and the refrigerant is supplied through the refrigerant passage 22c and the supply hole 15c5. As described above (FIG. 3), the oil bearing valve 31a and the refrigerant bearing valve 32a are provided in the oil passage 27a and the refrigerant passage 22a applied to the divided section R1, respectively, and the oil bearing valve 31b and the refrigerant bearing valve 32b are provided in the oil passage 27b and the refrigerant passage 22c applied to the divided section R3, respectively. In the present embodiment, only one of the oil or the refrigerant is supplied to each of the divided sections R1, R3 (that is, both the oil and the refrigerant are not supplied at the same time) by opening the oil bearing valves 31a, 31b or the refrigerant bearing valves 32a, 32b and closing the others, and open/closed states of such oil bearing valves 31a, 31b and such refrigerant bearing valves 32a, 32b are changed. In this way, the fluid to be supplied to each of the divided sections R1, R3 is switched between the oil and the refrigerant.

Furthermore, in the present embodiment, as illustrated in FIG. 4B, the slide bearing 15 is configured such that an inner diameter of the divided section R2, to which only the refrigerant is supplied, on the sliding surface is smaller than an inner diameter of each of the divided sections R1, R3, to which the oil is supplied, on the sliding surface. That is, an inner diameter of an intermediate portion (a central portion) of the slide bearing 15 in the axial direction is smaller than an inner diameter of each of the end portions of the slide bearing 15 in the axial direction. The divided sections R1, R3 are examples of the "first region" in the present disclosure, and the divided section R2 is an example of the "second region" in the present disclosure. That is, examples of the "first region" and the "second region" in the present disclosure include the divided sections R1, R3 and the divided section R2, respectively.

In addition, the slide bearing 15 is configured such that the inner diameter of the sliding surface is continuously changed along the axial direction in a manner such that the inner diameter of the divided section R2 is smaller than the inner diameter of each of the divided sections R1, R3. In particular, the slide bearing 15 is formed such that a cross section of the sliding surface viewed along the axial direction has an arc shape, in other words, is formed in a so-called crowning shape. More specifically, in the cross section viewed along the axial direction, the cross section of the sliding surface of the slide bearing 15 is formed in the arc shape such that an intermediate portion (e.g. the divided section R2) of the sliding surface protrudes radially inward while both end portions (e.g. the divided sections R1, R3) of the sliding surface are retracted radially outward.

According to such a slide bearing 15, since the inner diameter of the divided section R2 is smaller than the inner diameter of each of the divided sections R1, R3, the gap between the sliding surface of the slide bearing 15 and the rotation shaft 13 of the motor 1 is smaller in the divided section R2 than in the divided sections R1, R3. As a result, since the gap in the divided section R2, to which the refrigerant is supplied, is relatively small, load capacity by the refrigerant in this divided section R2 can be secured. Meanwhile, since the gap in each of the divided sections R1, R3, to which the oil is supplied, is relatively large, it is possible to suppress an increase in resistance by the oil in the divided sections R1, R3.

For convenience of description, the cross-sectional shape (that is, the arc shape, the crowning shape) of the sliding surface of the slide bearing 15 as described above is not illustrated in FIG. 3, which has been described above.

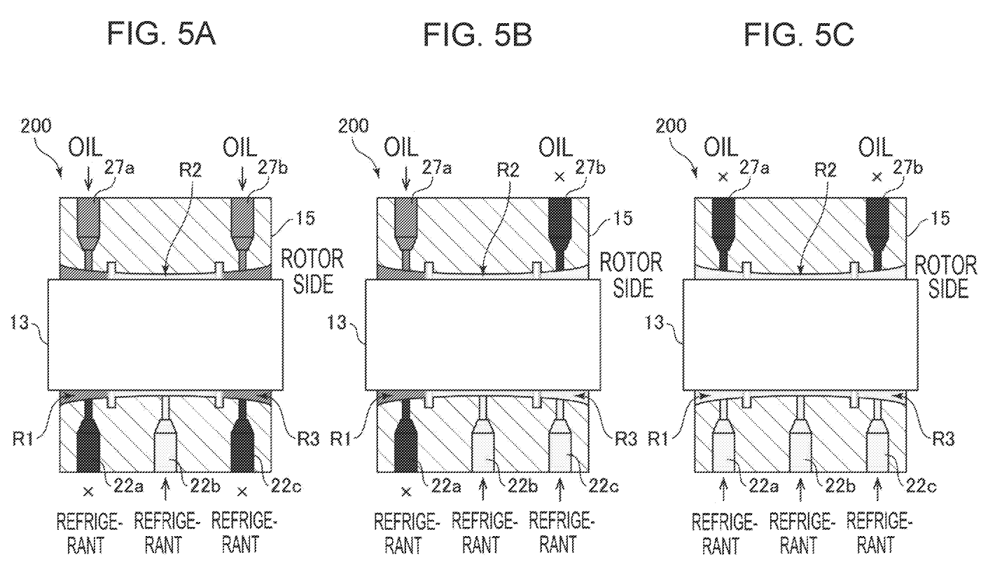

Next, a description will be made on switching between the oil and the refrigerant supplied to the divided sections R1, R3 according to the motor rotational frequency in the bearing system 200 according to the present embodiment with reference to FIG. 5. FIGS. 5A, 5B, and 5C illustrate a supply state of the oil or the refrigerant in one of the paired slide bearings 15 (the slide bearing 15 illustrated on the left in FIG. 3, that is, the slide bearing 15 on the side where the seal member 18 is provided) in a low rotation range, a medium rotation range, and a high rotation range, respectively. In FIGS. 5A, 5B, and 5C, a magnitude of the viscosity of the fluid is indicated by shading (the oil having a high viscosity is indicated by a dark shade, and the refrigerant having a low viscosity is indicated by a light shade). In addition, "↑" or "↓" indicates the supply of the corresponding fluid, and "x" indicates stopping of the supply of the corresponding fluid.

First, as illustrated in FIG. 5A, in the low rotation range of the motor rotational frequency, the refrigerant is supplied to the divided section R2 while the oil is supplied to both of the divided sections R1, R3. In this way, in the low rotation range, the load capacity of the slide bearing 15 is secured by the oil supplied to the divided sections R1, R3. In this case, the oil bearing valves 31a, 31b, which are respectively provided in the oil passages 27a, 27b, are opened while the refrigerant bearing valves 32a, 32b, which are respectively provided in the refrigerant passages 22a, 22c, are closed such that the oil is supplied to both of the divided sections R1, R3.

Next, as illustrated in FIG. 5B, in the medium rotation range of the motor rotational frequency, the refrigerant keeps being supplied to the divided section R2, and the oil is supplied to the divided section R1 while the refrigerant is supplied to the divided section R3. In this way, in the medium rotation range, the load capacity of the slide bearing 15 is secured to some extent by the oil supplied to the divided section R1 in the medium rotation range, while the refrigerant is supplied to the divided section R3 instead of the oil to suppress the increase in the resistance in the slide bearing 15. In this case, the oil bearing valve 31a provided in the oil passage 27a is opened to supply the oil to the divided section R1, while the refrigerant bearing valve 32a provided in the refrigerant passage 22a is closed. In addition, the oil bearing valve 31b provided in the oil passage 27b is closed to supply the oil to the divided section R3, while the refrigerant bearing valve 32b provided in the refrigerant passage 22c is opened.

Next, as illustrated in FIG. 5C, in the high rotation range of the motor rotational frequency (in particular, when the motor rotational frequency is extremely high), the refrigerant is supplied to both of the divided sections R1, R2 while the refrigerant keeps being supplied to the divided section R2. In this way, the refrigerant is supplied to all of the divided sections R1 to R3 in the high rotation range, and thereby the increase in the resistance in the slide bearing 15 is effectively suppressed. In this case, the oil bearing valves 31a, 31b, which are respectively provided in the oil passages 27a, 27b, are closed while the refrigerant bearing valves 32a, 32b, which are respectively provided in the refrigerant passages 22a, 22c, are opened such that the refrigerant is supplied to both of the divided sections R1, R2.

### Electrical Configuration

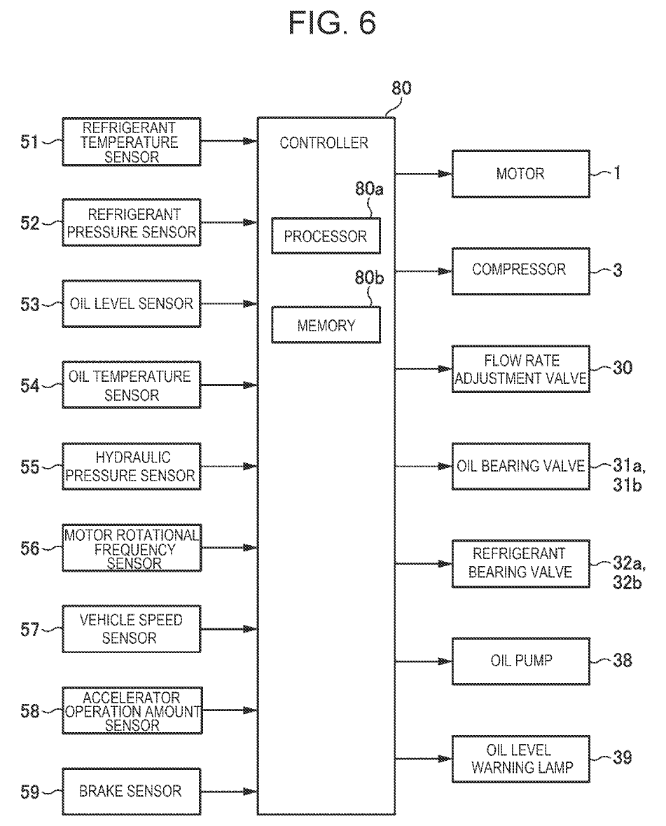

Next, an electrical configuration of the bearing system 200 according to the present embodiment will be described with reference to FIG. 6. FIG. 6 is a block diagram illustrating the electrical configuration of the bearing system 200 according to the present embodiment.

As illustrated in FIG. 6, the bearing system 200 includes a controller 80 that is configured to execute various types of control in the system. The controller 80 is configured with a computer that includes: one or more processors 80a (typically Central Processing Units (CPUs)); and memory 80b, such as Read-Only Memory (ROM) and Random-Access Memory (RAM), that stores various programs (including a basic control program such as an Operating System (OS) and an application program activated on the OS to implement a particular function) interpretively executed on the processor 80a and various types of data.

The bearing system 200 includes, in addition to the sensors 51 to 55 described above (see FIG. 2): a motor rotational frequency sensor 56 that detects a motor rotational frequency of the motor 1 (rotational frequencies of the rotor 11 and the rotation shaft 13, being equivalent to the rotational frequency); a vehicle speed sensor 57 that detects a speed (a vehicle speed) of the vehicle 300; an accelerator operation amount sensor 58 that detects an accelerator operation amount corresponding to a depression amount of an accelerator pedal in the vehicle 300; and a brake sensor 59 that detects an operation of a brake pedal in the vehicle 300.

The controller 80 supplies a control signal to the motor 1, the compressor 3, the flow rate adjustment valve 30, the oil bearing valves 31a, 31b, the refrigerant bearing valves 32a, 32b, the oil pump 38, and an oil level warning lamp 39 on the basis of detection signals from these sensors 51 to 59. The oil level warning lamp 39 is a lamp for warning that the level of the oil stored in the oil tank 6 (detected by the oil level sensor 53) is lower than a predetermined value.

In the present embodiment, the controller 80 mainly controls opening/closing of the oil bearing valves 31a, 31b and the refrigerant bearing valves 32a, 32b in order to switch the fluid supplied to the divided sections R1, R3 of the slide bearing 15 between the oil and the refrigerant on the basis of the motor rotational frequency detected by the motor rotational frequency sensor 56, and the like. More specifically, based on the motor rotational frequency, the controller 80 selectively executes: control for opening the oil bearing valve 31a and closing the refrigerant bearing valve 32a to supply the oil to the divided section R1; and control for closing the oil bearing valve 31a and opening the refrigerant bearing valve 32a to supply the refrigerant to the divided section R1, and, based on the motor rotational frequency, selectively executes: control for opening the oil bearing valve 31b and closing the refrigerant bearing valve 32b to supply the oil to the divided section R3; and control for closing the oil bearing valve 31b and opening the refrigerant bearing valve 32b to supply the refrigerant to the divided section R3.

### Control Method

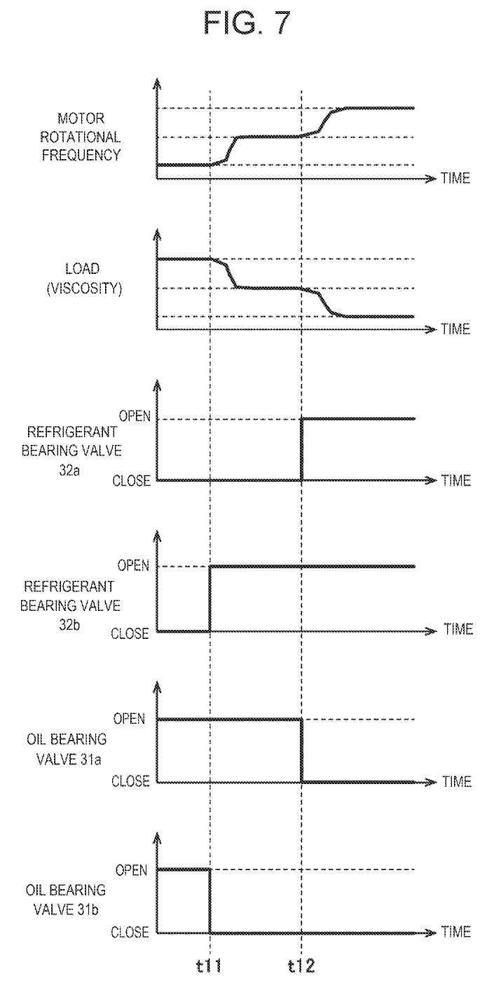

Next, a specific description will be made on the control executed by the controller 80 of the bearing system 200 in the present embodiment. First, a flow of the control executed by the controller 80 in the present embodiment will be described with reference to FIG. 7. FIG. 7 is a time chart illustrating the control according to the present embodiment. FIG. 7 illustrates, in an order from the top, temporal changes in the motor rotational frequency, the load applied by the slide bearing 15 (corresponding to the viscosity of the fluid in the slide bearing 15), opening/closing of the refrigerant bearing valve 32a, opening/closing of the refrigerant bearing valve 32b, opening/closing of the oil bearing valve 31a, and opening/closing of the oil bearing valve 31b.

As illustrated in FIG. 7, the motor rotational frequency is increased at time t11. As a result, the load to be realized by the slide bearing 15 (hereinafter, referred to as a "required load") that is determined according to the motor rotational frequency is reduced from a large load to a medium load. Accordingly, at such time t11, the controller 80 executes control for closing the oil bearing valve 31b and opening the refrigerant bearing valve 32b to switch the fluid supplied to the divided section R3 of the slide bearing 15 from the oil to the refrigerant in order to suppress the load of the slide bearing 15.

Thereafter, at time t12, the motor rotational frequency is further increased, and the required load is thereby reduced from the medium load to a small load. Accordingly, at such time t12, the controller 80 executes control for closing the oil bearing valve 31a and opening the refrigerant bearing valve 32a to switch the fluid supplied to the divided section R1 of the slide bearing 15 from the oil to the refrigerant in order to further suppress the load of the slide bearing 15.

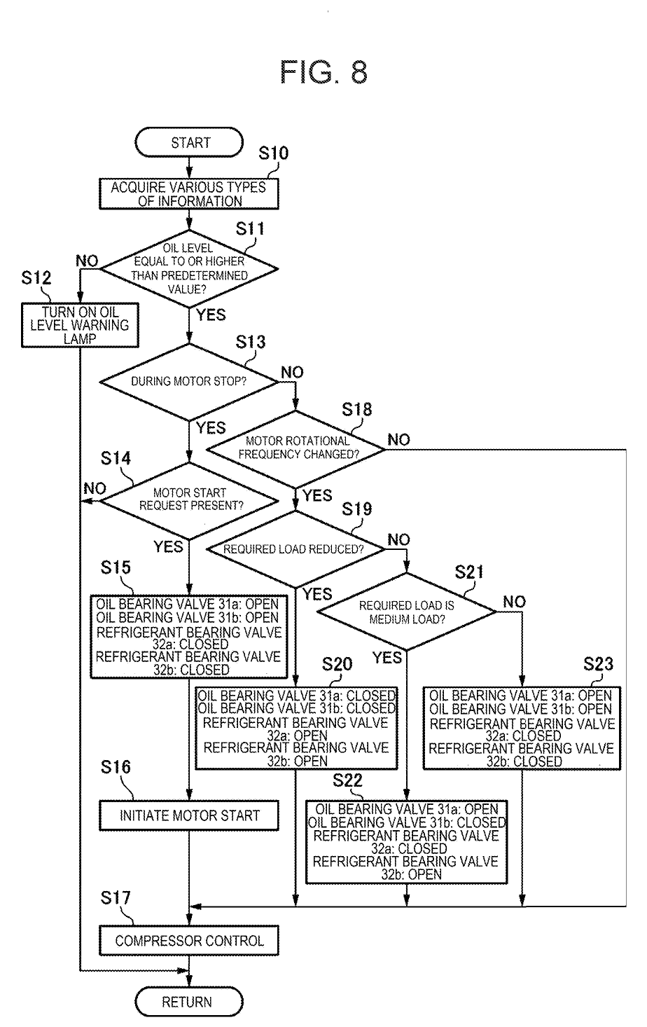

Next, a description will be made on a flowchart illustrating specific control according to the present embodiment with reference to FIG. 8. This flow is repeatedly executed by the controller 80 in a predetermined cycle. In detail, the processor 80a in the controller 80 reads the program stored in the memory 80b to execute the program, and thereby realizes the control for this flow.

First, in step S10, the controller 80 acquires various types of information such as the detection values detected by the sensors 51 to 59 (FIG. 6) described above. Then, the processing proceeds to step S11, and the controller 80 determines whether the oil level detected by the oil level sensor 53 is equal to or higher than the predetermined value. As a result, if the controller 80 does not determine that the oil level is equal to or higher than the predetermined value (step S11: No), that is, if the oil level is lower than the predetermined value, the processing proceeds to step S12, and the oil level warning lamp 39 is turned on.

On the other hand, if the controller 80 determines that the oil level is equal to or higher than the predetermined value in step S11 (step S11: Yes), the processing proceeds to step S13. In step S13, the controller 80 determines whether the motor 1 is stopped on the basis of the motor rotational frequency detected by the motor rotational frequency sensor 56, and the like. As a result, if the controller 80 determines that the motor 1 is stopped (step S13: Yes), the processing proceeds to step S14, and it is determined whether there is a motor start request on the basis of a start switch of the vehicle 300, the accelerator operation amount detected by the accelerator operation amount sensor 58, or the like. As a result, if the controller 80 determines that there is the motor start request (step S14: Yes), the processing proceeds to step S15. On the other hand, if it does not determine that there is the motor start request (step S14: No), the control according to this flow is terminated.

In step S15, the controller 80 opens the oil bearing valves 31a, 31b and closes the refrigerant bearing valves 32a, 32b to supply the oil to both of the divided sections R1, R3 of the slide bearing 15 in order to secure the load of the slide bearing 15 before the motor 1 is started. Then, the processing proceeds to step S16 to start the motor 1 and then proceeds to step S17, and the controller 80 executes control for adjusting the rotational frequency of the compressor 3.

On the other hand, if the controller 80 does not determine that the motor 1 is stopped in step S13 (step S13: No), that is, if the motor 1 is already in operation, the processing proceeds to step S18. In step S18, the controller 80 calculates a motor target rotational frequency on the basis of the accelerator operation amount detected by the accelerator operation amount sensor 58, or the like, and determines whether this motor target rotational frequency is changed. As a result, if the controller 80 determines that the motor target rotational frequency is changed (step S18: Yes), the processing proceeds to step S19. On the other hand, if it does not determine that the motor target rotational frequency is changed (step S18: No), the processing proceeds to step S17 without the processing in steps S19 to S23 being executed.

In step S19, the controller 80 calculates the required load of the slide bearing 15 on the basis of the motor rotational frequency detected by the motor rotational frequency sensor 56, and the like, and determines whether this required load is the small load. In this case, when the motor rotational frequency is in the high rotation range (in particular, when the motor rotational frequency is extremely high), the required load becomes the small load. As a result of step S19, if the controller 80 determines that the required load is the small load (step S19: Yes), the processing proceeds to step S20. In this case, the controller 80 closes the oil bearing valves 31a, 31b while opening the refrigerant bearing valves 32a, 32b to supply the refrigerant to both of the divided sections R1, R3 of the slide bearing 15. Then, the processing proceeds to step S17 described above.

On the other hand, if the controller 80 does not determine that the required load is the small load in step S19 (step S19: No), the processing proceeds to step S21. In step S21, the controller 80 determines whether the required load is the medium load. In this case, the required load becomes the medium load when the motor rotational frequency is in the medium rotation range. As a result of step S21, if the controller 80 determines that the required load is the medium load (step S21: Yes), the processing proceeds to step S22. In this case, the controller 80 opens the oil bearing valve 31a while closing the refrigerant bearing valve 32a to supply the oil to the divided section R1 of the slide bearing 15, and closes the oil bearing valve 31b while opening the refrigerant bearing valve 32b to supply the refrigerant to the divided section R3 of the slide bearing 15. Then, the processing proceeds to step S17 described above.

On the other hand, if the controller 80 does not determine that the required load is the medium load in step S21 (step S21: No), that is, if the required load is the large load, the processing proceeds to step S23. The required load becomes the large load when the motor rotational frequency is in the low rotation range. In this case, the controller 80 opens the oil bearing valves 31a, 31b while closing the refrigerant bearing valves 32a, 32b to supply the oil to both of the divided sections R1, R3 of the slide bearing 15. Then, the processing proceeds to step S17 described above.

Here, in steps S19, S21, the controller 80 determines the required load of the slide bearing 15. However, in another example, instead of the required load, the motor rotational frequency may be determined.

### Operation and Effects

Next, operation and effects of the bearing system 200 according to the present embodiment will be described.

In the present embodiment, the bearing system 200 includes: the slide bearing 15 that is lubricated by the oil and the refrigerant to support the rotation shaft 13; the oil passages 27a, 27b for supplying the oil to the first region of the sliding surface of the slide bearing 15; and the refrigerant passage 22b that is provided away from the oil passages 27a, 27b in the axial direction to supply the refrigerant to the second region, which differs from the first region, in the sliding surface. The slide bearing 15 is configured such that an inner diameter of the second region is smaller than an inner diameter of the first region.

According to such a present embodiment, since the inner diameter of the second region to which the refrigerant having the low viscosity is supplied is smaller than the inner diameter of the first region to which the oil having the high viscosity is supplied, in the slide bearing 15, the gap between the sliding surface of the slide bearing 15 and the rotation shaft 13 of the motor 1 is smaller in the second region than in the first region. As a result, since the gap in the second region to which the refrigerant is supplied is relatively small, the load capacity by the refrigerant in this second region can be secured. Meanwhile, since the gap in the first region to which the oil is supplied is relatively large, it is possible to suppress the increase in the resistance by the oil in this first region. Thus, according to the present embodiment, in the slide bearing 15 that uses the oil having the high viscosity and the refrigerant having the low viscosity, it is possible to secure the load capacity without increasing the resistance. Accordingly, when the refrigerant having the low viscosity is applied, the rotation shaft 13 is displaced in the radial direction, and thus it is possible to prevent a wasteful increase in the resistance.

In addition, according to the present embodiment, the slide bearing 15 is configured such that the inner diameter of the sliding surface is continuously changed along the axial direction in a manner such that the inner diameter of the second region is smaller than the inner diameter of the first region. In this way, since the gap between the sliding surface of the slide bearing 15 and the rotation shaft 13 of the motor 1 is continuously changed along the axial direction, it is possible to make a surface pressure applied to the sliding surface uniform.

In particular, according to the present embodiment, since the cross section of the sliding surface of the slide bearing 15 viewed along the axial direction is formed in the arc shape (that is, formed in the crowning shape), the surface pressure applied to the sliding surface can be effectively made uniform.

According to the present embodiment, the pair of the slide bearings 15 is provided to support the rotation shaft 13, each of the paired slide bearings 15 is configured to have the first regions in both of the end portions in the axial direction and have the second region in the intermediate portion (in particular, the central portion) between both of the end portions in the axial direction. That is, in the present embodiment, the oil having the high viscosity is supplied to both of the end portions in the axial direction, while the refrigerant having the low viscosity is supplied to the intermediate portion in the axial direction. Since the portion supplied with the oil having the high viscosity and the portion supplied with the refrigerant having the low viscosity are allocated in the axial direction in the slide bearing 15, it is possible to effectively secure the load capacity of the slide bearing 15 (in particular, the load capacity by the refrigerant).

According to the present embodiment, the bearing system 200 further includes: the refrigerant passages 22a, 22c for supplying the refrigerant to the first region; the oil bearing valves 31a, 31b and the refrigerant bearing valves 32a, 32b provided in the oil passages 27a, 27b and the refrigerant passages 22a, 22c, respectively; and the controller 80 configured to control opening/closing of each of the oil bearing valves 31a, 31b and the refrigerant bearing valves 32a, 32b to switch the fluid supplied to the first region between the oil and the refrigerant. In this way, the refrigerant can be selectively supplied to the first region instead of the oil, and it is thus possible to effectively suppress the increase in the resistance caused by the application of the oil in the slide bearing 15.

According to the present embodiment, based on the motor rotational frequency, the controller 80 selectively executes: the control for opening the oil bearing valve 31a and closing the refrigerant bearing valve 32a to supply the oil and/or the control for opening the oil bearing valve 31b and closing the refrigerant bearing valve 32b to the first region; and the control for closing the oil bearing valve 31a and opening the refrigerant bearing valve 32a and/or the control for closing the oil bearing valve 31b and opening the refrigerant bearing valve 32b to supply the refrigerant to the first region. In this way, the fluid supplied to the first region is switched between the oil and the refrigerant on the basis of the motor rotational frequency, and it is thus possible to accurately secure the load capacity in the low rotation range and reduce the resistance in the high rotation range.

According to the present embodiment, the slide bearing 15 includes the groove portions 15a that are formed on the sliding surface and extend in the radial direction and the circumferential direction, and the groove portions 15a divide the sliding surface of the slide bearing 15 into the plurality of divided sections R1 to R3 in the axial direction. In addition, the slide bearing 15 further includes the discharge hole 15b that is formed in the groove portions 15a to discharge the fluid from the slide bearing 15, and the first region and the second region are defined by the divided sections R1 to R3 that are divided by the groove portions 15a.

In such a present embodiment, since each of the fluids (the oil or the refrigerant) flows out from the discharge hole 15b through the groove portions 15a that define the divided sections R1 to R3, respectively, it is possible to prevent the fluid from being mixed in adjacent two of the divided sections R1 to R3. Thus, it is possible to prevent the fluid from being mixed in a portion between the first region and the second region that are defined by the divided sections R1 to R3. Therefore, according to the present embodiment, it is possible to effectively secure the load capacity and reduce the resistance in the slide bearing 15.

### Modified Examples

In the embodiment described above, the slide bearing 15 has the first regions, where the oil is supplied, in both of the end portions (corresponding to the divided sections R1, R3) in the axial direction. However, in a modified example, the first region may be provided to only one of the end portions (either one of the divided sections R1, R3) in the axial direction.

Furthermore, in the embodiment described above, the three divided sections R1 to R3 are formed in the slide bearing 15 by the two groove portions 15a. In the modified example described above, two divided sections may be formed by the single groove portion 15a, or three or more divided sections may be formed by the four or more groove portions 15a.

In addition, in the embodiment described above, the oil and CO₂ refrigerant are used as examples of the fluids having the different viscosities (the first and second fluids). However, any of various fluids other than the oil and CO₂ may be used.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

### REFERENCE CHARACTER LIST

1: motor

3: compressor

5: heat exchanger

6: oil tank

11: rotor

12: stator

13: rotation shaft

15: slide bearing

15a: groove portion

15b: discharge hole

15c1 to 15c5: supply hole

21 to 26: refrigerant passage

27, 28: oil passage

29: mixed fluid passage

80: controller

100: refrigerant circulation system

200: bearing system

300: vehicle

R1 to R3: divided section

What is claimed is:

1. A bearing system comprising:
a slide bearing that is lubricated by a first fluid and a second fluid having a lower viscosity than the first fluid and supports a rotation shaft;
a first passage for supplying the first fluid to a first region of a sliding surface of the slide bearing; and
a second passage that is provided away from the first passage in an axial direction and supplies the second fluid to a second region that differs from the first region in the sliding surface, wherein
the slide bearing is formed such that an inner diameter of the second region is smaller than an inner diameter of the first region.

2. The bearing system according to claim 1, wherein the slide bearing is formed such that an inner diameter of the sliding surface is continuously changed along the axial direction in a manner which makes the inner diameter of the second region smaller than the inner diameter of the first region.

3. The bearing system according to claim 2, wherein the slide bearing is formed such that a cross section of the sliding surface viewed along the axial direction has an arc shape.

4. The bearing system according to claim 1, wherein
the slide bearing is one of a pair of slide bearings provided to support the rotation shaft, and
each of the paired slide bearings has the respective first region in one or both of end portions in the axial direction, and has the respective second region in an intermediate portion between both of the end portions in the axial direction.

5. The bearing system according to claim 1 further comprising:
a third passage for supplying the second fluid to the first region;
a first valve and a second valve provided in the first passage and the third passage, respectively; and
a controller that controls opening/closing of each of the first valve and the second valve to switch a fluid to be supplied to the first region between the first fluid and the second fluid.

6. The bearing system according to claim 5, wherein
based on a rotational frequency of the rotation shaft, the controller selectively executes a control for opening the first valve and closing the second valve to supply the first fluid to the first region and a control for closing the first valve and opening the second valve to supply the second fluid to the first region.

7. The bearing system according to claim 1, wherein
the slide bearing further includes:
a groove portion that is formed in the sliding surface and extends in a radial direction and a circumferential direction, the groove portion dividing the sliding surface into a plurality of sections in the axial direction; and
a discharge hole that is formed in the groove portion to discharge the first and second fluids from the slide bearing, and
each of the first region and the second region is defined by a respective one of the plurality of sections divided by the groove portion.

8. The bearing system according to claim 1, wherein the first fluid is oil, and the second fluid is CO₂.

9. The bearing system according to claim 8, wherein the slide bearing supports the rotation shaft of a motor.

10. The bearing system according to claim 1, wherein the first fluid is oil, and the second fluid is CO₂.

11. The bearing system according to claim 2, wherein the first fluid is oil, and the second fluid is CO₂.

12. The bearing system according to claim 3, wherein the first fluid is oil, and the second fluid is CO₂.

13. The bearing system according to claim 4, wherein the first fluid is oil, and the second fluid is CO₂.

14. The bearing system according to claim 5, wherein the first fluid is oil, and the second fluid is CO₂.
